(19) United States
(12) Patent Application Publication
(10) Pub. No.: US 2002/0163163 A1
(43) Pub. Date: Nov. 7, 2002

(54) Folding walking or jogging stroller including pivoting wheel axle assemblies

(76) Inventor: Richard N. Shapiro, Virginia Beach, VA (US)

Correspondence Address: LARSON & TAYLOR, PLC, 1199 NORTH FAIRFAX STREET, SUITE 900, ALEXANDRIA, VA, 22314, US

(21) Appl. No.: 10/143,831

(22) Filed: May 14, 2002

Related U.S. Application Data
(63) Continuation-in-part of application No. 09/604,769, filed on Jun. 28, 2000.
(63) Continuation-in-part of application No. 09/271,274, filed on Mar. 17, 1999, now Pat. No. 6,220,611.

(51) Int. Cl. B62B 7/08

(52) U.S. Cl. 280/643; 280/644; 280/642

(57) ABSTRACT

A fold flat walking or jogging stroller is disclosed, which includes at least three wheels which all include pivoting wheel axles. The wheel axles include, in various embodiments, simple manually manipulable methods to latch each wheel in the operative or stowed flat positions, which effectively allows the device to fold to a flat profile without any wheel being detached. Associated innovations include a pivoting or floating rear wheel lateral axle, which pivots and latches to replicate a typical fixed rear wheel axle, but conveniently pivots to a fold flat stowed position.

### RELATIONSHIP TO OTHER APPLICATIONS

This application is a continuation-in-part of U.S. application Ser. No. 09/604,769 filed on Jun. 28, 2000.

Shapiro's previous U.S. Applications include U.S. Ser. No.: 09/271,274 filed on Mar. 17, 1999, now U.S. Pat. No.: 6,220,611, granted Apr. 24, 2001, as well as Shapiro's continuation-in-part U.S. patent application Ser. No.: 09/604,769, filed on Jun. 28, 2000.

### FIELD OF THE INVENTION

The present invention relates to folding, compact walking or jogging stroller devices, generally utilized for transporting children, whether including pneumatic or non-pneumatic tires.

### BACKGROUND OF THE INVENTION

In continuation-in-part U.S. patent application Ser. No.: 09/604,769, filed on Jun. 28, 2000, disclosures were made relating to compact, folding walking or jogging strollers. Innovations in the prior-referenced application related to the adaptation of pivoting wheel axles and methods for folding the pivoting wheel axles into a plane defined by the side elevational profile of the frame of the stroller device. Other significant innovations related to the manner in which the forward wheel is manipulated and stowed, methods to allow for rotation or fixation of the forward wheel, methods for latching and releasing all pivoting wheel axles in operative and stowed positions, and various methods relating to the flexible seat fabric.

### SUMMARY OF THE INVENTION

This application is a continuation-in-part of the application discussed above, and provides further refinements relating to: methods to latch and release the forward wheel into an operative and stowed position, methods to latch and release the rear wheels of the stroller device and to stow same substantially within the side elevational profile of the stroller frame, methods to provide automatic, reciprocating, or rotational action between various components of the rear wheel axle and frame components, alternative embodiments that provide for automatic folding and pivoting of said rear wheels and rear wheel component parts when the user manipulates a portion of the components and other related innovations that will become obvious by virtue of the disclosures herein.

Further features and advantages of the present invention will be set forth in, or apparent from, the detailed description of preferred embodiments thereof which follows.

### BRIEF DESCRIPTION OF THE DRAWING:

FIG. 1 is a side elevational view of the stroller 1-A;

FIG. 2 is a rear elevational perspective of the stroller in an operative position;

FIG. 3 is a side perspective of the stroller 1-A with the pivoting rear wheel lateral axle in a n an intermediate position;

FIG. 4-A is a side elevational perspective with the forward wheel in an intermediate position;

FIG. 4-B is a side elevational perspective with the forward wheel in a second intermediate position;

FIG. 4-C is a side elevational perspective with the forward wheel in a completely stowed position;

FIG. 5-A is a side elevational profile perspective with the forward wheel in an operative position;

FIG. 5-B is a side elevational perspective of the stroller with all wheels erected, however, with rear axle components in an intermediate, not fully erected position;

FIG. 5-C is an end elevational perspective of the stroller in a completely erected position, omitting the flexible fabric seat material;

FIG. 6-A is one of four figures is a series of figures showing an end elevational perspective of the pivoting and folding process involving the rear wheels of the stroller device;

FIG. 6-B is one of four figures is a series of figures showing an end elevational perspective of the pivoting and folding process involving the rear wheels of the stroller device;

FIG. 6-D is one of four figures is a series of figures showing an end elevational perspective of the pivoting and folding process involving the rear wheels of the stroller device;

FIG. 6-D is one of four figures is a series of figures showing an end elevational perspective of the pivoting and folding process involving the rear wheels of the stroller device;

FIG. 7-A is one of series of four side elevational, cross sectional views, indicating a sequence of process of the pivoting rear wheel lateral axle latching process wherein said component latches with a portion of the rear wheel pivoting axles;

FIG. 7-A is one of series of four side elevational, cross sectional views, indicating a sequence of process of the pivoting rear wheel lateral axle latching process wherein said component latches with a portion of the rear wheel pivoting axles;

FIG. 7-B is one of series of four side elevational, cross sectional views, indicating a sequence of process of the pivoting rear wheel lateral axle latching process wherein said component latches with a portion of the rear wheel pivoting axles;

FIG. 7-C is one of series of four side elevational, cross sectional views, indicating a sequence of process of the pivoting rear wheel lateral axle latching process wherein said component latches with a portion of the rear wheel pivoting axles; and

FIG. 7-D is one of series of four side elevational, cross sectional views, indicating a sequence of process of the pivoting rear wheel lateral axle latching process wherein said component latches with a portion of the rear wheel pivoting axles.

### DESCRIPTION OF THE PREFERRED EMBODIMENT

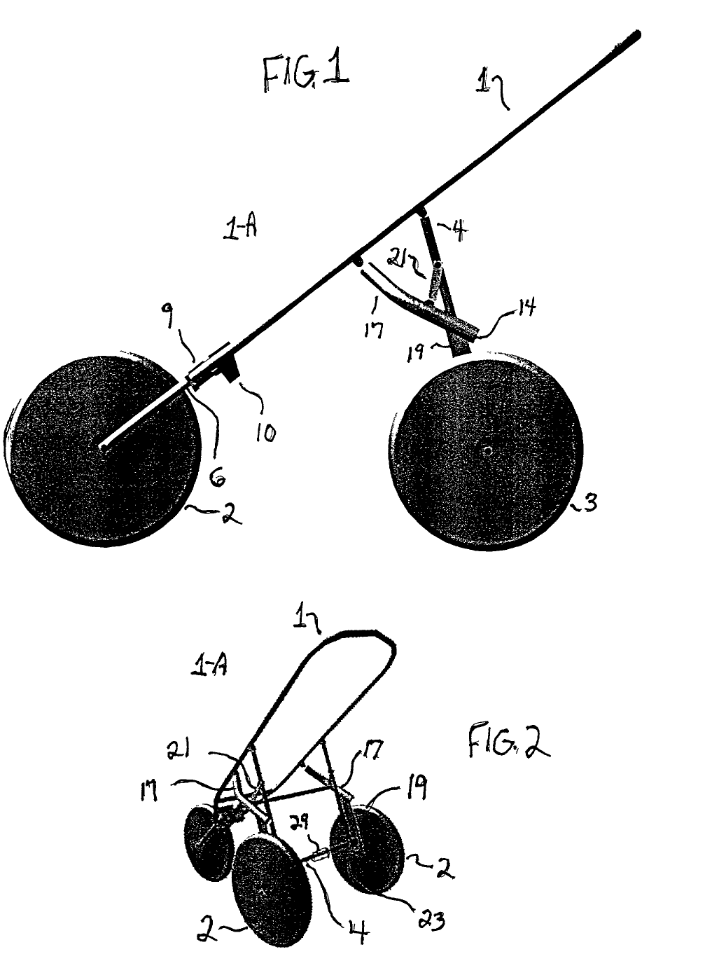

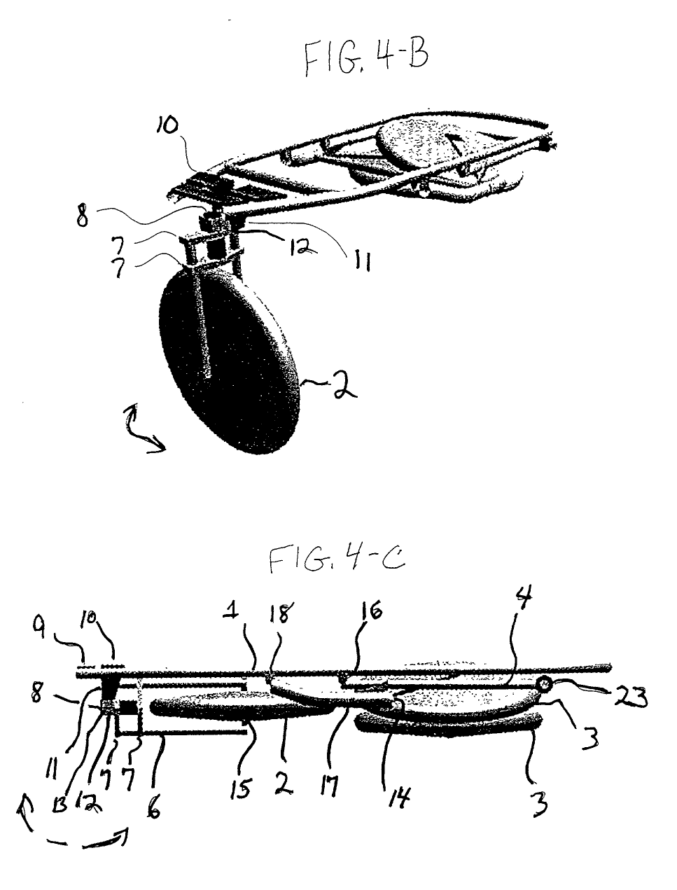

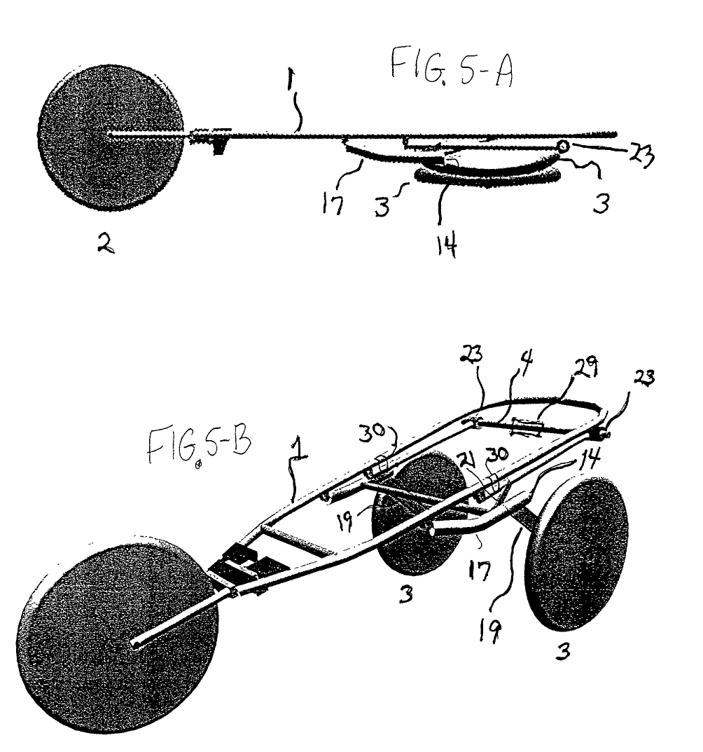

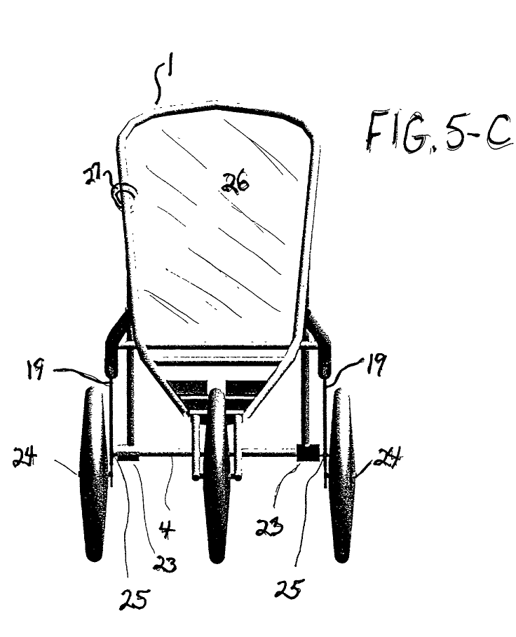

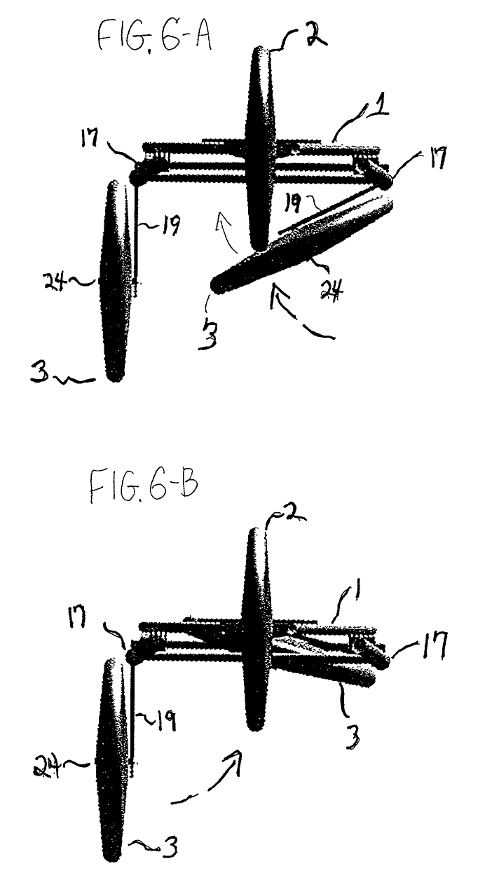

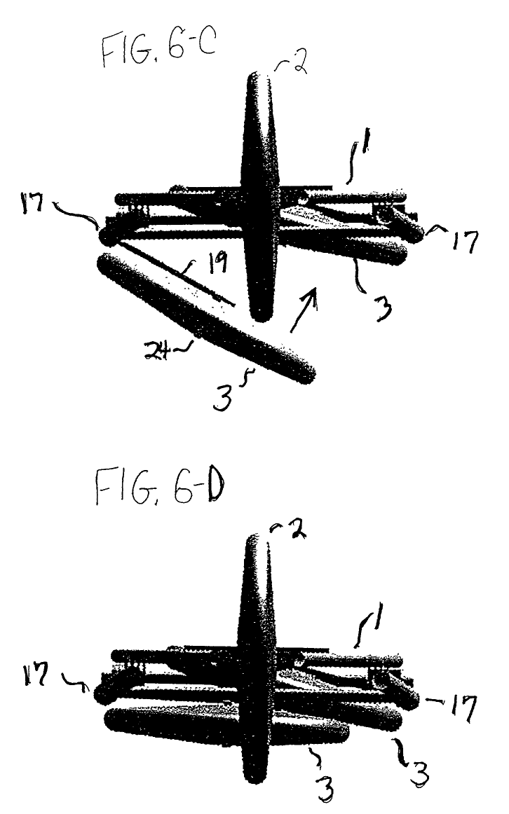

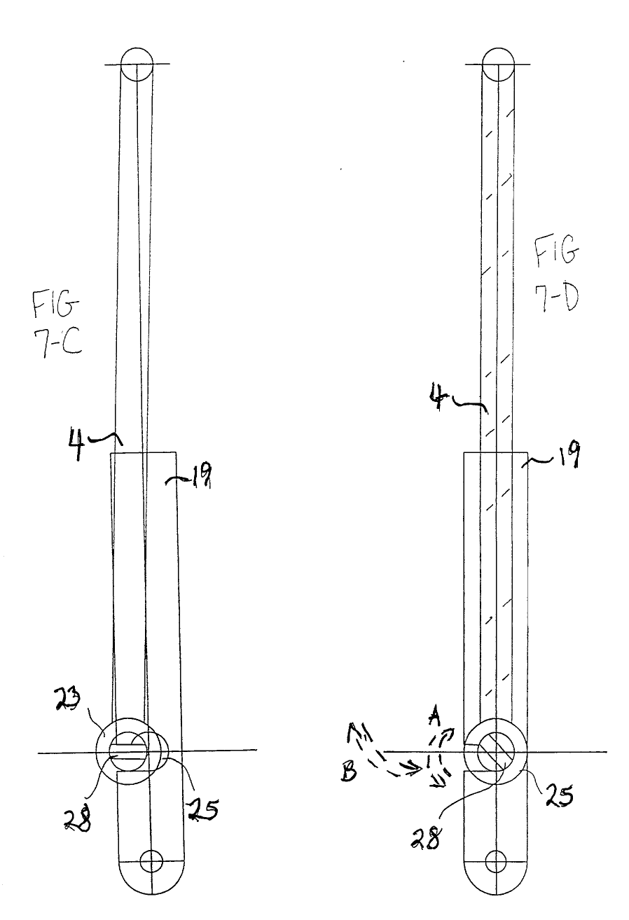

Referring to the drawings, FIGS. 1 and 2 show a stroller device, generally denoted as 1-A, in an operative position (for reference, the stroller device 1-A is shown in a completely stowed position in FIG. 4-C). Referring to FIGS. 1 and 2 particularly, the stroller device is shown in the operative position with a pair of rear wheels (3) and a forward wheel (2). Describing the rear wheel components first, a movable rear wheel support arm (17) is pivotally mounted to the fixed frame (1) in two locations. Two other components are mounted to the said movable rear wheel support arms (17), those components being a rear wheel pivoting axle (19), and additionally an interconnection arm (21). Rear wheel pivoting axle component (19) at one end pivots along the movable rear wheel support arm (17) and at its other termination point is the axle which travels through the center of the rear wheel (3) which provides rolling support to the device. A second rear wheel component is pivotally mounted to the fixed frame (1), that being the pivoting (floating) rear wheel lateral axle (4). The pivoting/floating rear wheel lateral axle innovation is shown in FIG. 2, and at its lateral extremities most remote from the fixed frame interconnects with both of the rear wheel pivoting axles (19), by virtue of a pair of pivoting rear wheel axle connectors (23) (See FIG. 5-C), which positively latch with rear wheel pivoting axle reception cavities (25) (not shown here, shown in a series of FIGS. 7-A through 7-D). Referring particularly to FIG. 1, the forward wheel components primarily include the forward wheel fork (6), the fixed frame forward wheel stop/brace (9), and the frame footrest (10). It is understood that the flexible seat fabric (26) and flexible seat fabric retaining members (27) are not shown in these figures, but that said stroller device will include these components in actual construction (See FIG. 5-C).

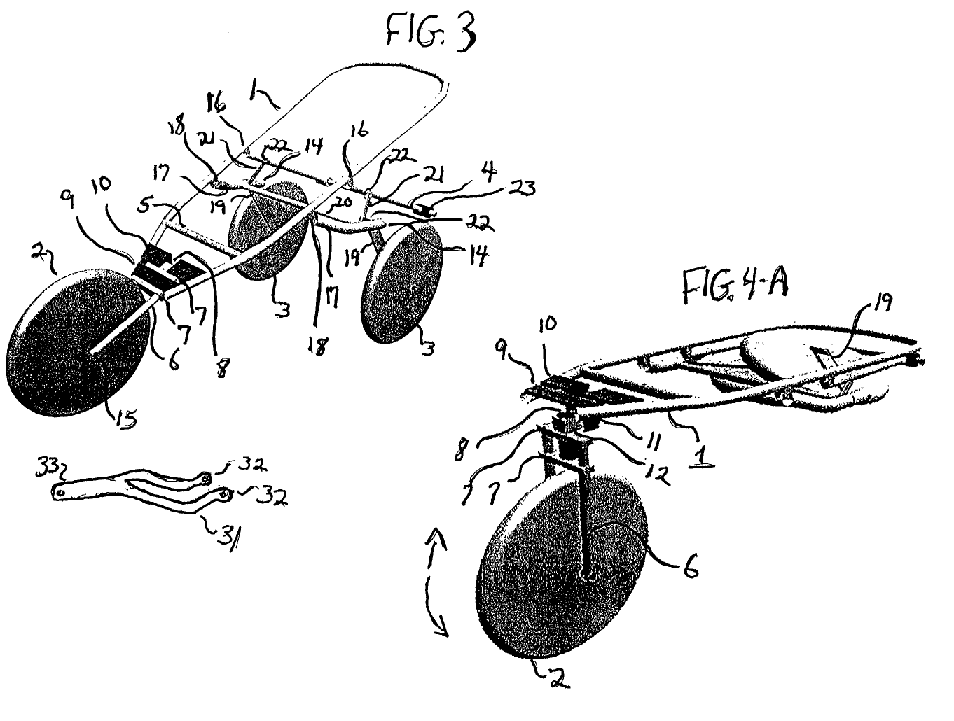

Referring to FIG. 3, this figure provides further perspective on the folding operation of the stroller device 1-A. Particularly this figure shows the pivoting rear wheel lateral axle (4) in motion, in the midpoint of its pivoting motion. The lateral axle (4) includes the pivoting rear wheel lateral axle connectors on either end of the lateral portion of the component which interconnects to the rear wheel pivoting axles (19), however, in this view, said pivoting rear wheel lateral axle has been released, by motion of the user (not shown), and is in intermediate position showing that this component pivots along the fixed frame lateral axle mounting member (16) and ultimately the pivoting rear wheel axle (4) stows flush with fixed frame (1). This figure in perspective shows several other components including the fixed frame lateral brace (5), which may be in a different position or similar to that shown in FIG. 3, the movable rear wheel support (17), mounting members (18) along which the movable rear wheel support arms (17) are mounted. A pair of movable rear wheel support arms (17) are interconnected by virtue of a movable rear wheel support lateral brace (20). Additionally, at the rear-most opening point of the movable rear wheel support arms (17) is a spring-biased button (14). Each push button (14) allows the user to pivot the rear wheels (3) 90° between the stowed and operative positions. As can be seen in FIG. 3, the interconnection arm (21) has the purposeful effect of causing the rear wheels, which are mounted on the movable rear wheel support arms (17), as well as the rear wheel pivoting axles (19), to retract generally away from the fixed frame (1), at such time as the user grasps the pivoting rear wheel lateral axle (4) and pivots it away from its flush profile with the fixed frame (1). According, the motion of the pivoting rear wheel lateral axle pivoting downward in the direction toward the ground, causes overall movement of the movable rear wheel support arm to pivot along its mounting member (18) by virtue of the interconnection arm (21). The interconnection arms (21) are pivotally mounted by virtue of pins (22).

Last, referring further to FIG. 3, is shown a forward fork trailing bracket accessory (31). This is an accessory which would permit the stroller device to be interconnected to another vehicle such as a bicycle or other wheeled propelled device that is not shown. The user would remove the forward wheel (2) shown in FIG. 3 by releasing it from the forward wheel fork tire mount (15). Using the same mounting bolt (15), the user would engage the bracket accessory (31) through the mounting holes (32) and then the bolt (15) is rethreaded through the forward wheel fork (6). Any other suitable portion of the forward wheel trailing bracket accessory (31) may be affixed to a portion of a mounting accessory on the other propelled vehicle (not shown in FIG. 3) and a suitable portion of the bracket accessory (31) may be mounted at a point similar to the vehicle mounting hole (33) shown on the bracket (31). In this fashion the stroller device may be propelled behind any vehicle.

Referring to the series of FIGS. 4-A through 4-C, a method whereby the forward wheel moves from an operative position to a stowed position is depicted. Before referring to the sequence of FIGS. 4-A through 4-C, initial reference to FIG. 3 shows the forward wheel fork (6) as well as wheel fork cross braces (7) in latched position on the device fixed frame forward wheel stop/brace (9) as well as frame footrest (10), and referring now to FIG. 4-A, it is indicated that the frame footrest (10) mounted to the fixed stroller frame (1), includes a downwardly projecting pivot bracket (11) which may be formed from two extensions of the frame footrest (10) although any suitable arrangement may be employed to create a pivoting mount for the forward wheel fork (6). In FIG. 4-A, the rear wheels are already in a stowed position, and the forward wheel (2) has been unlatched by virtue of forward wheel fork spring biased release button (8) incorporated into a suitable portion of the forward wheel fork pivot head (12). The forward wheel fork (6) includes one or more suitable lateral braces (7). Fixed frame forward wheel stop/brace (9) serves as a movement stop against which the forward wheel fork (6) and its cross braces (7) align when the forward wheel is in the completely latched, operative position (See also FIG. 3). Once the forward wheel fork (6) is freed by virtue of the user pressing the spring biased release button (8), the user may pivot the forward wheel (2) in its same plane, down and away from its operative position in one axis, and then the user, as shown in FIG. 4-B, pivots the forward wheel (2) 90° in a second axis, and once the wheel is pivoted 90° in the second axis, the user may further continue the motion of the forward wheel (2) pressing it up and under until the forward wheel (2) is in a plane parallel with the stroller fixed frame (1) adjacent to said fixed frame (1), until said wheel lies substantially within the perimeter or profile of said fixed frame, at which time the spring biased release button (8) causes re-latching of the forward wheel (2) and its general components, close to or substantially within the side elevational profile of the strolling device as shown in FIG. 4-C. It is also noted that the forward wheel (2) when stowed in this fully latched and stowed position is prevented from fully pivoting or general rotation as a portion of the forward wheel fork (6) and/or its cross braces (7) are trapped within the confines of a suitable portion of the forward wheel stop (9), and frame footrest (10). For the user to take the forward wheel (2), from the stowed position, the operation would be reversed by the user first pressing the spring biased release button (8).

FIGS. 5-A through 5-C help depict mechanisms which allow the rear wheels to be manipulated from the stowed, folded position, to their completely erected position. Referring to FIG. 5-A, a side elevational perspective is shown of the fixed frame (1) with the forward wheel (2) already erected or placed in operative position. In order to erect the rear wheels, the following steps are taken: the user would press, the movable rear wheel support (17) spring bias button (14) located at the extremity of each movable rear wheel support furthest from the fixed frame (1). When said spring bias button (14) is pressed, the user grasps its associated rear wheel (3) and the release button (14) allows the wheel to pivot along its rear wheel pivoting axle (19) approximately 90° so that the rear wheel is erected substantially perpendicular with the axis of the fixed frame (1). The same process is duplicated for the second rear wheel (3). Further referring to FIG. 5-B, the rear wheels have been placed into their perpendicular position, and at this point the user would grasp a suitable portion of the pivoting or floating wheel lateral axle (4) and free the pivoting rear wheel lateral axle from its retainers (30) which hold it in a stowed profile adjacent to the fixed frame (1). The downward movement of the pivoting rear wheel lateral axle (4) causes further retraction of each of the rear wheels (3) because the lateral axle (4) is interconnected with the movable rear wheel support arms (17) by virtue of the pair of interconnection arms (21) so that pivoting the lateral axle (4) downward further causes interaction between other said components. As can be seen in FIG. 5-C at the point where the extremities of the rear wheel lateral axle (4) intersects with the rear wheel pivoting axles (19), the pivoting rear wheel lateral axle connectors (23) contact, and then travel into the rear wheel pivoting axle reception cavities (25) (indicated in FIG. 5-C and shown in more detail in FIGS. 7-A through 7-D below). FIG. 5-C does not show the spring biased latching members on the extremities of the lateral axle (4). Also, in FIG. 5-B is indicated a pivoting rear wheel lateral axle securing ring (29), which is of a cylindrical shape and the user manipulates and rotates about a quarter turn once the pivoting rear wheel lateral axle (4) has engaged and connected to each rear wheel pivoting axle (19) and this rotation of the securing ring serves to further secure the lateral axle (4) into the structure of each rear wheel pivoting axle. FIG. 5-C also indicates at 26 that a flexible seat fabric will be included with the stroller device which will be connected at suitable positions along the fixed frame (1) by virtue of any number of flexible seat fabric retaining members (27). FIG. 5-C also shows the rear wheel pivoting axle tire mounting bolts (24).

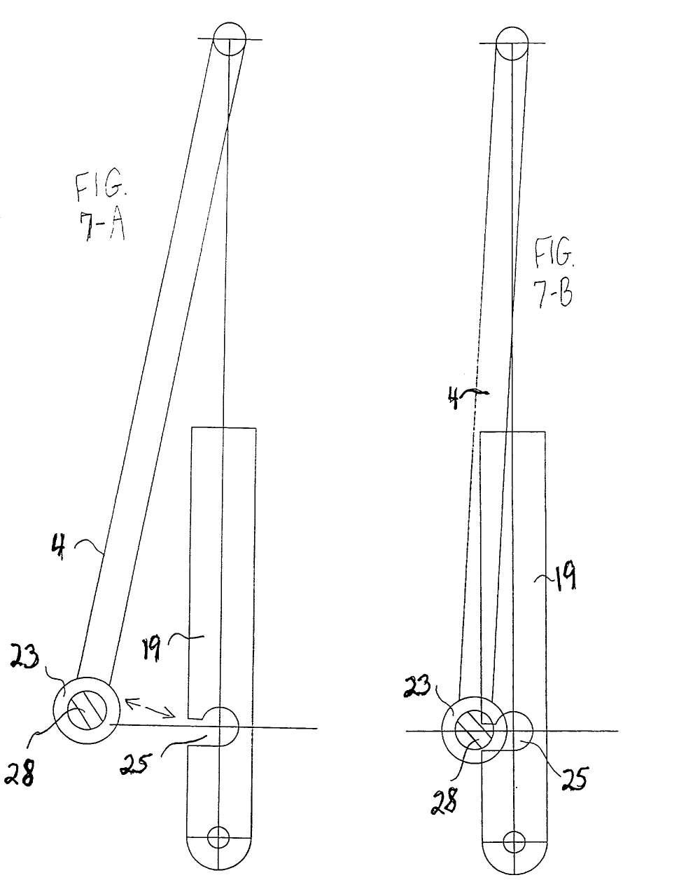

Referring to FIGS. 6-A through 6-C, is shown an end elevational perspective looking from front to rear, showing the general stowing of the rear wheels. The rear wheel tires (3) are shown, and in FIG. 6-A, the first of the rear wheels is an intermediate step of being stowed approximately 90° from the operative to the stowed position. First, the user would press the movable rear wheel support spring biased button (14) (not shown), which would permit pivoting of said tire (3) mounted on the rear wheel pivoting axle (19) which component is permitted to pivot along the movable rear wheel support arm (17). Fixed frame (1) is shown as well as the forward wheel (2) in its operative position. In FIG. 6-B, the first of the indicated stowed rear wheels (3) is latched automatically within the side elevational profile of the stroller frame (1) because of automatic reengagement of the latch within the movable rear wheel support (17). FIG. 6-B indicates the pivoting motion of the second rear wheel (3) and FIG. 6-C shows an intermediate pivoting motion of the second rear wheel, followed by FIG. 6-D in which the final rear wheel (3) has attained a completely stowed position, at which point it is automatically latched in said stowed position by virtue of the movable rear wheel support spring biased button and latch within said button (14) which is a part of the movable rear wheel support arm (17).

The series of FIGS. 6-A through 6-D show a stroller embodiment where the rear wheels stow in a sandwiched configuration, but it is appreciated that depending upon the width of the stroller device (a double stroller or jogger) the same folding motion may be accomplished where the rear wheels do not sandwich or overlay each other, but each occupy a side-by-side relationship also substantially within the stowed side elevational profile of the device.

A further alternative embodiment of the rear wheel unfolding function causes an automatic rotational force on the two wheel arms so that the pivoting of the pivoting rear wheel lateral axle (4) not only serves to lower or raise the rear wheels in relation to the fixed frame (1), but further causes the tires to rotate into perpendicular operative position or parallel stowed position in relation to the fixed frame (1). In this application, FIGS. 6-A through 6-D show manual pivoting of the rear wheels, but instead the movable rear wheel support arms (17), as explained earlier, are lowered and raised by motion of the pivoting or floating rear wheel lateral axle (4). However, in this embodiment, not shown, the rotation action of the movable rear wheel support arms (17) creates a further rotational force on the rear wheel pivoting axles (19), which force causes the automatic rotation of the rear wheel pivoting axles (19) either to a stowed, or an operative position. Accordingly, the rear wheels (3) automatically stow in either a sandwiched or an overlaid relationship, or in a side-by-side relationship depending on the overall width dimension of the stroller device.

FIG. 7-A through FIG. 7-D indicate the latching and releasing motion between the pivoting (or floating) rear wheel lateral axle (4) and the rear wheel pivoting axle (19). The lateral extremities of the pivoting rear wheel axle includes connectors (23) which each includes a spring biased latching member (28) which components are received in the rear wheel pivoting axle reception cavities (25) which are a portion of the rearwheel pivoting axles (19). In one representative embodiment of the latching function (although any suitable latching mechanism may be employed), the latching member (28) includes a spring biased mechanism and at the point the connector (23) pivots and arrives at the reception cavity (25), 7-B and 7-C indicate that the latching member (28) turns between 45 to 90° allowing it to then snap back or spring back into a latching position as seen in FIG. 7-D. Accordingly the spring biased function locks the pivoting rear wheel lateral axle (4) into the suitable cavity (25) in the rear wheel pivoting axle (19). In FIG. 7-D the letter “A” indicates that there is a further securement method involving the pivoting rear wheel lateral axle (4) which is actuated by manual rotation of a securing ring (29) which is further seen in FIG. 2 and FIG. 5-D. The ring allows rotation along the pivoting/floating rear wheel lateral axle (4) so that a part of each of the connectors (23) correspondingly rotate axially to engage or disengage the rear wheel pivoting axle (19) between facing portions of the pivoting/floating rear wheel lateral axle (4) itself. Referring back to FIG. 7-D, the user turns the securing ring (29) which is a portion of the pivoting rear wheel lateral axle (4) and the rotation of the ring serves to further secure portions of the pivoting rear wheel lateral axle connectors snugly against the rear wheel pivoting axle (19). The reverse movement of the ring (29) as shown at “A” and then at “B” unlatches or releases the pivoting/floating rear wheel lateral axle (4) from each rear wheel pivoting wheel axle (19) in order to pivot and stow the lateral axle (4).

Although the invention has been described above in relation to preferred embodiments thereof, it will be understood by those skilled in the art that variations and modifications can be effected in these preferred embodiments without departing from the scope and spirit of the invention.

What is claimed:

1. A stroller device for transporting children, said device comprising:
a support frame defining a side elevational profile and an outer perimeter;
a flexible seat element affixed to said support frame which forms a seat when said seat element is in a first, operative position disposed out of the side elevational profile of the support frame and which collapses so as to be disposed substantially within the side elevational profile of the support frame when said seat element is in a second, stowed position; and
at least three wheel assemblies affixed to said support frame; each of said wheel assemblies comprising a wheel defining a plane, and said wheel assemblies each being movable between a first, operative position wherein said wheels are erected to provide rolling support for said support frame and wherein the plane defined by each of said wheels extends substantially orthogonally to the side elevational profile of the support frame, and a second, stowed position, the plane defined by each of said wheels being swept through an angle during movement of said wheel assemblies between said first and second positions such that the plane defined by each of said wheels in the second position of said wheel assemblies extends substantially parallel with the side elevational profile of said support frame, said wheels being disposed substantially within the outer perimeter defined by the support frame in the second position of said wheel assemblies.

2. A stroller device in accordance with claim 1 wherein the flexible seat element is removably affixed to said support frame so as to be selectively removable therefrom.

3. A stroller device in accordance with claim 1 further comprising a separable seat frame removably affixed to said support frame so as to be selectively repositionable on and removable from the support frame, said flexible seat element being affixed to said seat frame.

4. A stroller device in accordance with claim 1 further comprising manually releasable latching means for providing selective retention of said wheel assemblies in the first, operative position thereof and in the second, stowed position thereof.

5. A stroller device in accordance with claim 4, wherein a said manually releasable latching means is integrated into each of said wheel assemblies.

6. A stroller device in accordance with claim 4 wherein said manually releasable latching means is disposed within the side elevational profile of the support frame.

7. A stroller device in accordance with claim 4 wherein said manually releasable latching means includes at least one spring-biased latch.

8. A stroller device in accordance with claim 4 wherein said manually releasable latching means includes at least one resiliently mounted, manually operated latch member.

9. A stroller device in accordance with claim 1 wherein said wheel assemblies include a wheel support member received between adjacent spaced facing portions of said support frame, and wherein said latching means includes at least one spring biased latch for, in a latched state, engaging one of said facing portions of said support frame to latch said wheel support member in place and thus latch the associated wheel assembly in the first, operative position thereof.

10. A stroller device in accordance with claim 9 wherein said latching means include first and second spring-biased latches each engaging a respective one of said facing portions of the support frame in the latched state thereof, and finger-activated release means for disengaging said latches from the latched states thereof.

11. A stroller device in accordance with claim 10 wherein said first latch comprises a first latch member and a first biasing spring disposed in a first cavity in one side of said wheel support member and said second latch comprises a second latch member and a second biasing spring disposed in a second cavity in an opposed side of said wheel support member, said facing portions of said support frame each including a respective recess in which a respective latch member is received in the latched state thereof.

12. A stroller device in accordance with claim 11 wherein said finger actuated release means includes spaced access openings in said wheel support member and a respective opening in each of said latch members for enabling the latching members to be moved toward each other against the biasing force of said springs to release said latch members from the recesses in said facing portions of said support frame.

13. A stroller device in accordance with claim 9 wherein said adjacent facing portions of said support frame include facing cavities therein and at least two of said wheel assemblies include oppositely extending pivot elements which are received in said cavities and about which the associated wheel support member pivots.

14. A stroller device in accordance with claim 13 wherein said pivot elements comprise opposite end portions of a pivot shaft and said wheel support member includes a transversely extending opening at a pivot end thereof through which said pivot shaft extends.

15. A stroller device in accordance with claim 1 wherein at least one wheel includes an outer rim and a central hub and said hub including a transverse opening therein, and said wheel assembly for said at least one wheel including a wheel support member, and an elongate wheel support element, said wheel support element including a transverse portion at said first end received in said opening in said hub and forming an axle about which said wheel rotates, and a further portion extending orthogonally to said transverse portion and being received in said support member, said further portion terminating in said second end, and said wheel support member including a cavity therein disposed adjacent to said second end, and said wheel support assembly further comprising a terminal fixing member affixed to said second end of said support element and received in said cavity, said fixing member being of size and shape relative to that of said cavity so as to prevent rotation thereof in said cavity, whereby axial rotation of said further portion is prevented and thus said at least one wheel is prevented from rotation about said further portion and is limited to rotation about an axis formed by said first portion.

16. A stroller device in accordance with claim I wherein said wheel assemblies each includes a spring biased retaining means for retaining said wheel assemblies in the operative position thereof and in the inoperative position thereof, and a movable mounting member to which a respective wheel is affixed, each said resilient retaining means further comprising a resilient male-female connection between said movable mounting member and a fixed member of the stroller device.

17. A stroller device in accordance with claim 16 wherein said retaining means includes a pair of oppositely disposed retaining elements and a corresponding pair of finger grips for controlling movement of the respective retaining elements between a retaining position and a release position.

18. A stroller device in accordance with claim 1 wherein at least one said wheel assemblies includes means for fixating a support axle for the corresponding wheel so as to prevent rotation of the corresponding wheel.

19. A stroller device in accordance with claim 1 wherein at least one said wheel assemblies includes releasable means for fixating the position of the corresponding wheel about said axis defined by a support axle for said wheel and for, when released, permitting 360 rotation of the corresponding wheel about said axis.

20. A stroller device in accordance with claim 1 wherein said at least one of said wheel assemblies includes a wheel mounting member including a central longitudinal throughhole through which a support shaft for the corresponding wheel extends and a recess in one surface thereof in communication with said throughhole, said stroller device further comprising an end cap disposed in said recess and connected to one end of said support shaft, the other end of said support shaft being connected to the corresponding wheel.

21. A stroller device in accordance with claim 1 wherein said flexible seat element comprises a flexible fabric member disposed between opposing sides of said support frame so that in said first, operative, position of said flexible element the feet of a child may rest within said flexible fabric member, and in the second, stowed, position of said flexible element the flexible fabric member is collapsed into a parallel plane disposed at least close to being within the side elevational profile of the support frame.

22. A stroller device in accordance with claim 1 wherein two wheels assemblies of said at least three wheel assemblies are mounted on opposite sides of said support frame, the wheels of said two wheel assemblies, in the second, stowed, position of said two wheel assemblies, being positioned in at least partially overlapping relation and being disposed at least close to being in a plane parallel with the side elevational profile of the support frame, and at least close to being within the perimeter defined by said support frame.

23. A stroller device in accordance with claim 1 wherein opposing wheels of at least two of said wheel assemblies, in the second, stowed, position of the at least two wheel assemblies, are disposed in a plane substantially parallel with the side elevational profile of the support frame.

24. A stroller device in accordance with claim 1 further comprising a separable retention element mounted on a forward portion of said support frame, and an element for affixing said support frame of the stroller device to a separate wheeled device to thereby couple the devices together for rolling movement.

25. A stroller device in accordance with claim 24 wherein the wheel of at least one of the forwardmost said wheel assemblies, in the second, stowed position of the at least one wheel assembly, is retained in a plane substantially parallel with the side elevational profile of the support frame, and said separable retention element is affixed to both the stroller support frame and a portion of the separate wheeled device so that the separate wheeled device may serve to pull the devices.

26. A stroller device in accordance with claim 1 further comprising a user selectable, manually manipulable means permitting selective fixation of an axle of the wheel of at least one of the wheel assemblies, against rotation as well as selective 360 axial rotation of said wheel of said at least one wheel assembly.

27. A stroller device for transporting children, said device comprising:
a support frame;
a flexible seat element affixed to said support frame which forms a seat when said seat element is in a first, operative position and which collapses into a second, stowed position;
a plurality of wheels supporting the support frame; and
a wheel-support assembly for supporting at least one of said wheels, said at least one wheel including an outer rim and a central hub and said hub including a transverse opening therein, and said wheel support assembly including a wheel support member, and an elongate wheel support element, said wheel support element including a transverse portion at a first end thereof received in said opening in said hub and forming an axle about which said wheel rotates, and a further portion extending orthogonally to said transverse portion and being received in said support member, said wheel support assembly further comprising fixing means engaging said further portion of said support element so as to prevent rotation thereof, whereby axial rotation of said further portion is prevented and thus said at least one wheel is prevented from rotation about said further portion of said wheel support element and is limited to rotation about an axis formed by said first portion of the wheel support element.

28. A stroller device for transporting children, said device comprising:
a support frame defining a side elevational profile;
a seat frame member mounted on said support frame and movable between a first, operative position wherein the seat frame member is disposed out of the profile of said support frame and a second, stowed position wherein the seat frame is disposed substantially within the profile of said support frame;
a flexible seat element affixed to said seat frame member so as to form a seat when said seat frame member is in the operative position thereof and to collapse so as to be disposed substantially within the profile of the support frame in the stowed position of the seat frame member; and
a plurality of wheels affixed to said support frame and movable between a first, operative position wherein said wheels are erected to provide rolling support for said support frame, and a second, stowed position wherein said wheels are displaced through an angle from said first position so as to be disposed at least close to being within said side elevational profile, said wheels pivoting through an angle of 270 between said first and second positions thereof.
